(19) United States
(12) Patent Application Publication
(10) Pub. No.: US 2026/0275951 A1
(43) Pub. Date: Sep. 17, 2026

(54) Vortex Flow Generation of Electricity

(71) Applicant: UpTerra Corporation, San Rafael, CA (US)

(72) Inventor: Ahmad Reza Givsan, San Rafael, CA (US)

(21) Appl. No.: 18/868,681

(22) PCT Filed: May 24, 2023
(86) PCT No.: PCT/US2023/023451

§ 371 Date: Nov. 22, 2024

(51) Int. Cl. F03B 13/00; C10M 105/24; C10M 125/04; C10M 169/04; C10N 40/00; H02K 7/116; H02K 7/18

(52) U.S. Cl. CPC F03B 13/00; C10M 105/24; C10M 125/04; C10M 169/04; H02K 7/116; H02K 7/1823; C10M 2201/05; C10M 2207/1203; C10N 2040/40

(57) ABSTRACT

A device for extracting energy from a fluid is described. The device comprises a turbine disposed inside an egg-shaped container. The walls of the egg-shaped container direct fluid through the turbine. The walls can have a substantially phi-curvature to structure the fluid molecules.

This application is a national stage filing of PCT/US 23/23451, filed on May 24, 2023, which claims priority to U.S. provisional application serial number 63/345337, filed on May 24, 2022.

### FIELD OF THE INVENTION

The field of the invention is electric energy generation, and more specifically, converting mechanical energy into electrical energy.

### BACKGROUND

The background description includes information that may be useful in understanding the present invention. It is not an admission that any of the information provided herein is prior art or relevant to the presently claimed invention, or that any publication specifically or implicitly referenced is prior art.

It is well known that water molecules will organize into clusters or “coherent domains” when exposed to electromagnetic fields, due to change in molecule oscillations. US2006/0273020 to Bagley, for example, teaches using an oscillating crystal to modify or “structure” water molecule clusters. Bagley also teaches connecting the crystal to a battery to oscillate the crystals at specific frequencies for different purposes. US20140170059 to Czech teaches using electrodes and salt in water to electrically discharge water clusters and improve efficacy against micro-organism. US20210228718 to Camisasca teaches irradiating water with light energies at specific combinations of frequency ranges to medically treat patients suffering from poor sense of balance.

Bagley, Czech, Camisasca, and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

It would be advantageous to provide devices, systems, and methods for extracting energy from structured fluids.

Thus, there remains a need for improved devices, systems, and methods for energy generation.

### SUMMARY OF THE INVENTION

The inventive subject matter provides methods and devices for extracting energy from a fluid by converting mechanical energy into electrical energy. Contemplated devices comprise an egg-shaped container and a turbine disposed inside the egg-shaped container. The turbine is mechanically coupled to a generator or alternator, such that operation of the turbine produces electrical energy from the generator or alternator. The container has a wall that creates a fluid path configured to direct at least some of the fluid through the turbine.

The turbine has one or more turbine blades positioned about a rotating shaft. As fluid flows past the blades, a centrifugal force rotates the shaft. In especially preferred embodiments, the rotating shaft has a lumen filled with metal particles suspended in a suspension medium. The metal particles can be selected from the list consisting of AG, Cu, In, and Au. The suspension medium preferably includes a fatty acid. The fatty acid can comprise a medium chain triglyceride, such as coconut oil. The metal particles and suspension medium inside the rotating shaft aid in structuring the fluid molecules into clusters of coherent domains.

The egg-shaped container defines a lumen having a volume. Contemplated volumes for the lumen are between 2 liters and 1000 liters, more preferably between 2 liters and 500 liters, still more preferably between 2.5 liters and 3 liters, and most preferably 2.33 liters. What is more relevant than the volume per se, is having the container volume between 4.5 and 5.5 times the output volume at some given moment. More preferable embodiments have a container volume between 4.8 and 5.2 times the output volume at some given moment, and the most preferable embodiments have a container volume of approximately 5 times the output volume at some given moment

The egg-shaped container can have an inlet that directs the fluid into the egg-shaped container in a first direction, and an outlet that provides an exit for the fluid out of the egg-shaped container in a second direction. The first and second direction can either be parallel or non-parallel. In some embodiments, the second direction can be orthogonal to the first direction. In such embodiments, the inlet can be disposed at an end of the egg-shaped container. and an outlet can be disposed at a side of the egg-shaped container.

Contemplated devices can also include a funnel disposed within the lumen of the egg-shaped container, and at least a portion of the turbine is disposed within the funnel. The funnel and/or the egg-shaped container can have a side wall that has a phi-shaped curvature. The phi-shaped curvature of the egg-shaped container and/or funnel helps to structure the fluid molecules into clusters of coherent domains. The walls of the egg-shaped container and funnel create a vortex fluid path that improves efficiency of electric energy generation.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a side cross-sectional view of one embodiment of a device for extracting energy from a fluid.

FIG. 2 is a side view of the turbine in FIG. 1.

FIG. 3 is a side cross-sectional view of another embodiment of a device for extracting energy from a fluid.

### DETAILED DESCRIPTION

The following discussion provides many example embodiments of the inventive subject matter. The embodiments described herein are not intended to be an exhaustive list or to limit the inventive subject matter to the precise form disclosed. The disclosed embodiments are chosen and described to merely explain the principles of the inventive subject matter and its application and practical use so as to enable others skilled in the art to follow its teachings.

The inventive devices, systems, and methods will be understood, both as to its structure and operation, from the accompanying drawings, taken in conjunction with the accompanying description. Although each embodiment represents a single combination of inventive elements, the inventive subject matter is considered to include all possible combinations of the disclosed elements. As such, it should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise. Thus, if one embodiment comprises elements A, B, and C, and a second embodiment comprises elements B and D, then the inventive subject matter is also considered to include other remaining combinations of A, B, C, or D, even if not explicitly disclosed.

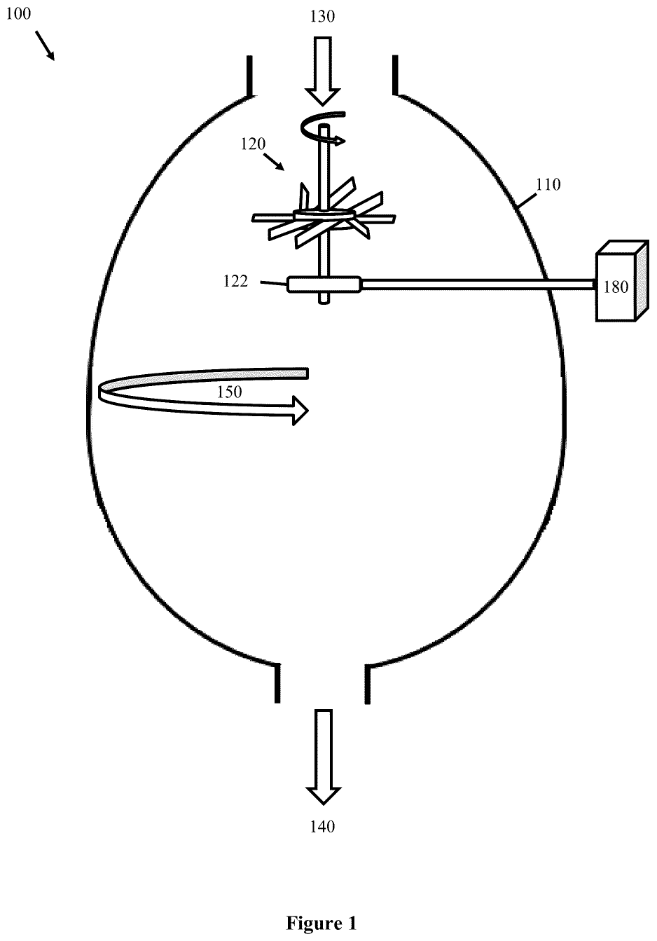

FIG. 1 shows a device 100 for extracting energy from a fluid by converting mechanical energy into electrical energy. Device 100 has an egg-shaped container 110 with an inlet 130 and an outlet 140. A fluid such as water flows into inlet 130 in a vortex fluid path 150. The fluid passes through turbine 120 and causes turbine 120 to rotate. The fluid then exits the egg-shaped container out of outlet 140. Turbine 120 is coupled with a generator or alternator 280 via one or more gears 122 to convert mechanical energy (e.g., rotating shaft 124) into electrical energy.

The egg-shaped container 110 has a first half and a second half (e.g., a top half and a bottom half as shown in FIG. 1). The wall of the first half has a more elongated curvature than the walls of the second half. However, it is also contemplated that the first half and second half have identical curvatures, such as egg-shaped container 310 shown in FIG. 4. Inlet 130 forms frusto-ovoid in the first half of egg-shaped container 110 and outlet 140 forms a frusto-ovoid in the second half of egg-shaped container 110.

As used herein, “egg-shaped” means an ovoid shape having continuously varying circular cross-sections that narrower near the ends and widen near the middle. The ovoid shape can be symmetrical or non-symmetrical (e.g., the first half has a different curvature than the second half).

In some embodiments, at least a portion of the wall of the egg-shaped container 110 has a substantially phi-curvature. Phi is defined as the golden ratio (1.618). As used herein, “substantially” phi curvature means approximately 1.618, preferably within 1.4 and 1.8, more preferably within 1.5 and 1.7, and most preferably within 1.58 and 1.65.

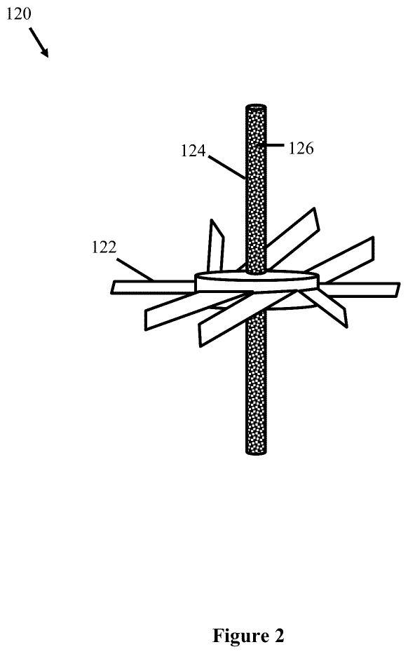

FIG. 2 shows turbine 120. Turbine 120 has a plurality of blades 122 extending radially outward from a rotating shaft 124. Rotating shaft 124 has a lumen 126 filled with metal particles suspended in a suspension medium. Shaft 124 can be supported inside egg-shaped container 110 using one or more supports (not shown), which may include one or more bearings to minimize friction between shaft 124 and the supports.

The metal particles can be selected from the group consisting of AG, Cu, In, and Au. The suspension medium can be a fatty acid that comprises a medium chain triglyceride, such as coconut oil. The metal particles cause fluid molecules passing by turbine 120 to cluster into coherent domains, thereby improving efficiency of energy generation.

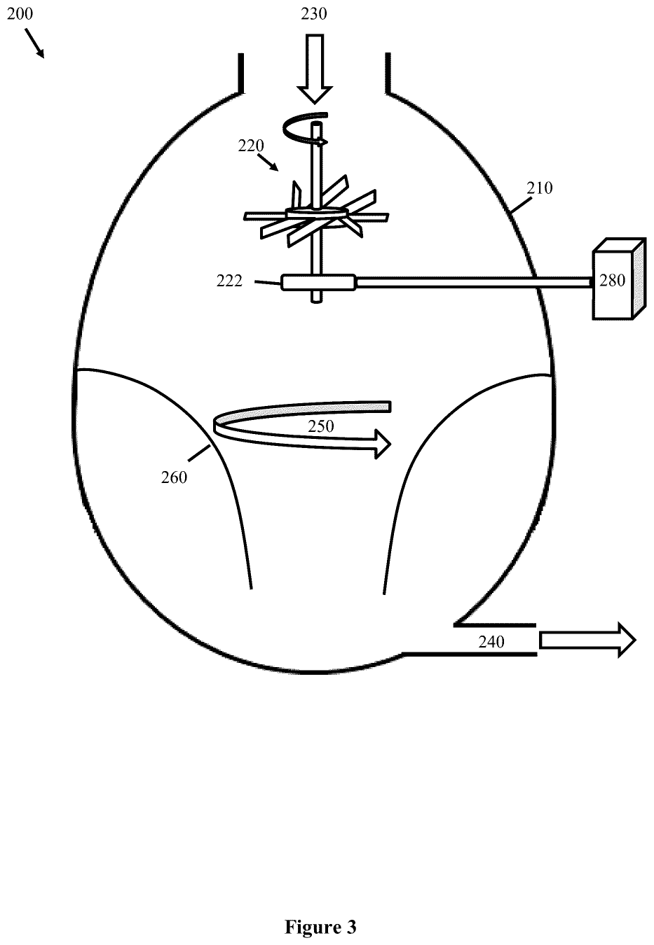

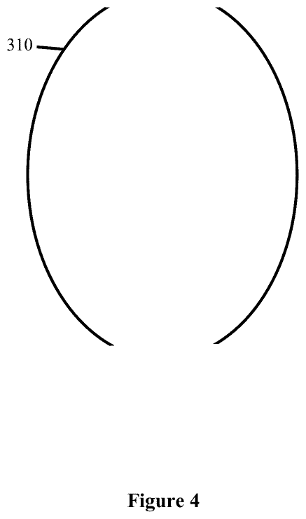

FIG. 3 shows a device 200 for extracting energy from a fluid by converting mechanical energy into electrical energy. Device 200 is similar to device 100 except that outlet 240 is orthogonal to inlet 230 and turbine 220 is disposed inside a funnel 260. Funnel 260 has walls with a substantially phi-curvature. Funnel 260 facilitates the structuring of fluid molecules into clusters of coherent domains, thereby improving efficiency of energy generation.

As used herein, and unless the context dictates otherwise, the term “attached to” and “coupled to” are intended to include both direct coupling (in which two elements that are coupled to each other contact each other) and indirect coupling (in which at least one additional element is located between the two elements). Therefore, the terms “attached to,” “coupled to,” “attached with,” and “coupled with” are used synonymously.

It should be apparent to those skilled in the art that many more modifications besides those already described are possible without departing from the inventive concepts herein. The inventive subject matter, therefore, is not to be restricted except in the spirit of the amended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification refers to at least one of something selected from the group consisting of A, B, C . . . and N, the text should be interpreted as requiring only one element from the group, not A plus N, or B plus N, etc.

What is claimed is:

1. A device for extracting energy from a fluid, comprising:
an egg-shaped container;
a turbine disposed inside the egg-shaped container and mechanically coupled to a generator or alternator, such that operation of the turbine produces electrical energy from the generator or alternator; and
a fluid path configured to direct at least some of the fluid through the turbine.

2. The device of claim 1, wherein the turbine has a turbine blade positioned about a rotating shaft, and metal particles are suspended in a suspension medium within a lumen of the rotating 4 shaft.

3. The device of claim 2, wherein the metal particles are selected from the list consisting of AG, Cu, In, and Au.

4. The device of claim 2, wherein the suspension medium includes a fatty acid.

5. The device of claim 4, wherein the fatty acid comprises a medium chain triglyceride.

6. The device of claim 1, further comprising an inlet that directs the fluid into the egg-shaped container in a first direction, and an outlet that provides an exit for the fluid out of the egg-shaped container in a second direction that is orthogonal to the first direction.

7. The device of claim 1, further comprising an inlet disposed at an end of the egg-shaped container. and an outlet at a side of the egg-shaped container.

8. The device of claim 1, wherein the egg-shaped container defines a lumen having a volume of at least 1.85 gal or 1:1.618 GPM/60 .

9. The device of claim 1, further comprising a funnel within the egg-shaped container, and at least a portion of the turbine is disposed within the funnel.

10. The device of claim 1, wherein the egg-shaped container has a side wall having a phi-shaped curvature.
